(19) United States
(12) Patent Application Publication
(10) Pub. No.: US 2014/0106197 A1
(43) Pub. Date: Apr. 17, 2014

(54) SUBMERSIBLE INCLUDING AN ELECTROCHEMICAL BATTERY

(71) Applicants: Francois Gerlier, Marseille (FR); Thomas Senez, Sainte-Maxime (FR); Alexandre Lemasquerier, Bayeux (FR)

(72) Inventors: Francois Gerlier, Marseille (FR); Thomas Senez, Sainte-Maxime (FR); Alexandre Lemasquerier, Bayeux (FR)

(73) Assignee: DCNS, Paris (FR)

(21) Appl. No.: 13/824,232

(22) PCT Filed: Apr. 13, 2012
(86) PCT No.: PCT/EP2012/056824

§ 371 Date: Dec. 16, 2013

(30) Foreign Application Priority Data
Apr. 15, 2011 (FR) 11 01192

(51) Int. Cl. H01M 6/32

(52) U.S. Cl. CPC H01M 6/32
USPC 429/113

(57) ABSTRACT

The submersible according to the invention comprising an electrochemical battery activated by an electrolyte, designed to produce the electrical power for powering said submersible, the electrochemical battery comprising:
an electrochemical cell (3) for producing electrical power,
a tank (4) for containing the electrolyte,
means (7) for reducing the flow of the electrolyte between the electrochemical cell (3) and the tank (4), said flow-inducing means including an axial flow pump axially arranged in the tank and including a motor-driven wheel rotatably mounted in a diffuser, is characterized in that the wheel of the pump is not asymmetric.

The present invention relates to a submersible, in particular such as a torpedo.

Such submersibles, for example consisting of a torpedo such as a so-called “heavy” torpedo, comprise an electrochemical battery activated by an electrolyte and which is intended to produce electricity powering the rest of the submersible for its operation, motorization, etc.

Such electrical power supply means for these types of submersibles are already known in the state of the art.

Reference may thus for example be made to document EP A 0307292, which describes a device for forming and inducing the flow of a liquid electrolyte in a water-activated alkaline battery for this type of application.

In fact, in that document, the electrochemical battery comprises an electrochemical cell producing electrical power, a tank designed to contain the electrolyte, and means for inducing the flow of the electrolyte between the electrochemical cell and the tank, said flow-inducing means comprising a pump.

Also traditionally, the pumps used may be axial flow pumps positioned axially in the tank and comprising a motor-driven water wheel and for example associated with an electric drive motor, said water wheel being rotatably mounted in a diffuser.

Other types of pumps, for example such as vane pumps or others, have also been proposed for this type of application.

However, all of the proposed solutions have a certain number of drawbacks, in particular in terms of the acoustic discretion of the submersible.

It is in fact known that one important operating characteristic of this type of submersible, in particular when it consists of a weapon such as a torpedo, is its ability to be discreet, in particular acoustically speaking, so as to be detected as late as possible by the corresponding acoustic detection means of a target.

The aim of the invention is therefore to resolve these problems by improving the acoustic discretion of such submersibles.

To that end, the invention relates to a submersible, comprising an electrochemical battery activated by an electrolyte, designed to produce the electrical power for powering said submersible, the electrochemical battery comprising:
an electrochemical cell for producing electrical power,
a tank for containing the electrolyte,
means for reducing the flow of the electrolyte between the electrochemical cell and the tank, said flow-inducing means including a semi-axial flow pump axially arranged in the tank and including a motor-driven wheel rotatably mounted in a diffuser, characterized in that the wheel of the pump is not axisymmetric.

According to other features of the submersible, considered alone or in combination:
the diffuser is generally in the shape of a dome for discharging the flow of electrolyte at the outlet of the pump in a direction substantially parallel to the axis of the pump and therefore of the tank;
at least part of the interface of the diffuser includes vanes with axes offset relative to the axis of the pump;
the diffuser is suitable for discharging the electrolyte at the outlet of the pump over 360° around the axis thereof, and
it consists of a torpedo.

The invention will be better understood using the following description, provided solely as an example and done in reference to the appended drawings, in which:

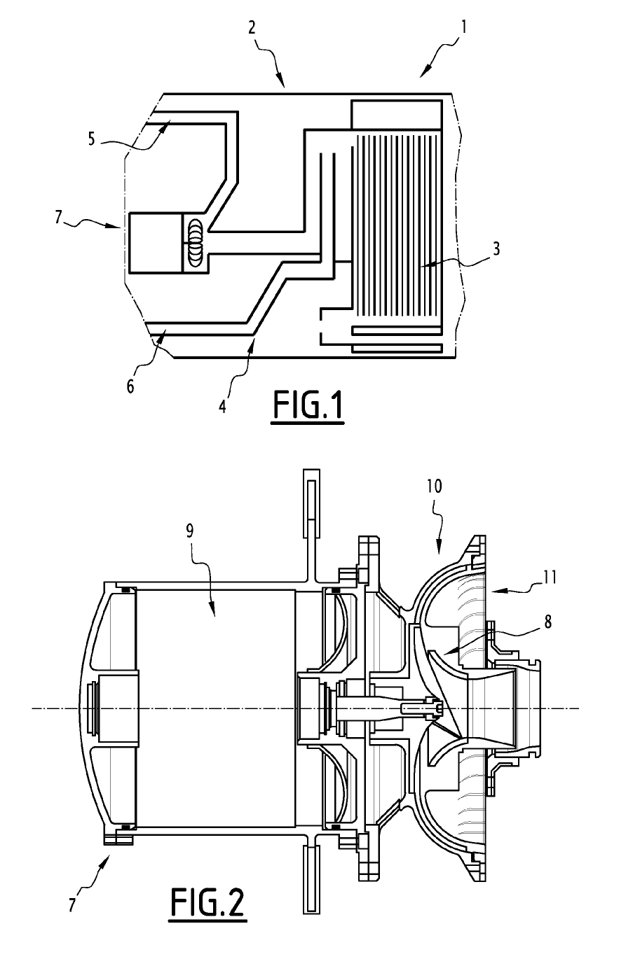

FIG. 1 is a block diagram illustrating the general structure of an electrochemical battery section included in the composition of a submersible according to the invention;

FIG. 2 is a cross-sectional side view of an axial flow pump included in the composition of such a submersible;

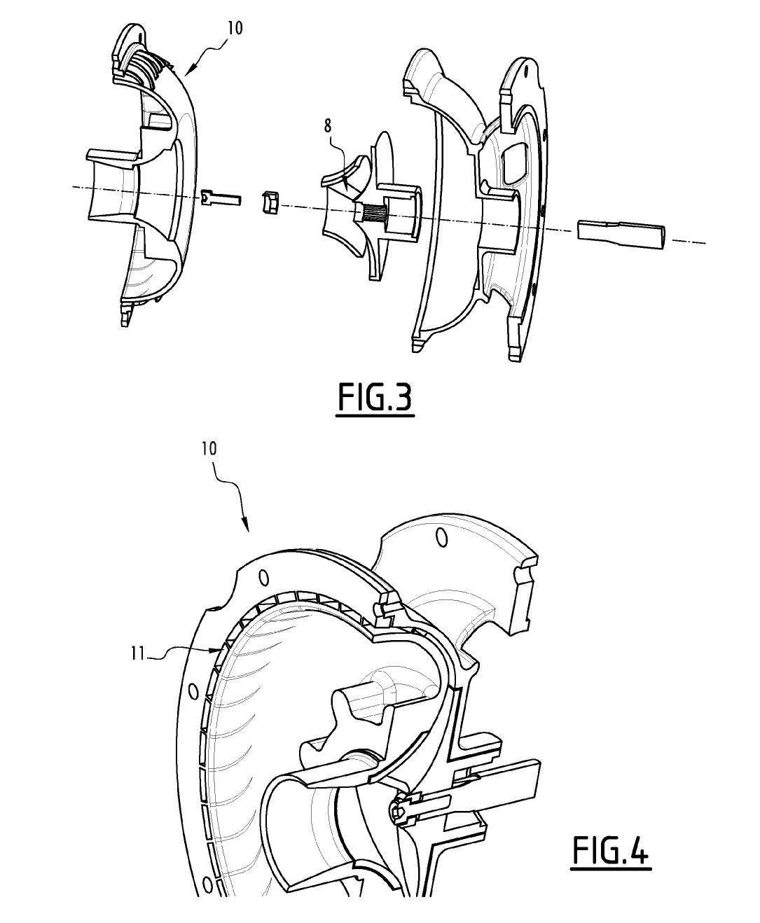

FIG. 3 is a partial exploded and cross-sectional view of a wheel and a diffuser included in the composition of such a pump; and

FIG. 4 shows a partial perspective side view of a diffuser included in the composition of such a pump.

These figures, and in particular FIG. 1, in fact show a portion of a submersible designated by general reference 1, and for example made up of a so-called “heavy” torpedo.

The portion of the submersible more particularly illustrated is the portion referred to as the “battery” section 2 of such a submersible.

Traditionally, and as described in the aforementioned prior document, this battery is an electrochemical battery activated by a electrolyte and designed to produce the electrical energy for powering the rest of the submersible for the operation, motorization, etc. thereof.

This electrochemical battery also comprises an electrochemical cell for producing electrical energy designated by general reference 3 in said FIG. 1, associated with a tank designed to contain the electrolyte, the tank being designated by general reference 4.

The tank and the rest of the submersible are for example cylindrical.

The electrolyte may assume the form of a liquid or anhydric, the battery section in that case traditionally including a seawater intake duct capable of bringing seawater into the tank so as to dissolve the electrolyte in anhydrous form in order to form a liquid electrolyte, when the latter is activated.

In FIG. 1, these seawater intake means are formed by a conduit designated by general reference 5.

Furthermore and also traditionally, a discharge conduit for discharging the gases resulting from the electrochemical cell may also be provided, that conduit being designated by general reference 6.

This degassing being traditional and using traditional degassing means, it will not be described in more detail hereafter.

Lastly, in this section, means are also provided for inducing the flow of the electrolyte between the electrochemical cell and the tank, those means being designated by general reference 7 in said FIG. 1.

This flow makes it possible to monitor the operation, and in particular to control the temperature of the electrochemical cell as described in the aforementioned EP document.

These means for inducing the flow of the electrolyte between the electrochemical cell and the tank are formed by a semi-axial flow pump positioned axially in the tank, and for example whereof the inlet is connected to the cell and the outlet is connected to the tank.

That pump then traditionally includes a motor-driven water wheel for example associated with an electric motor and rotatably mounted in a diffuser.

That semi-axial flow pump 7 is illustrated in more detail in FIGS. 2, 3 and 4.

These figures, and in particular FIG. 2, show the means for inducing the flow of the electrolyte, designated by general reference 7.

As previously indicated, these flow-inducing means include an axial flow pump including a motor-driven wheel designated by general reference 8 in these figures and for example associated with an electric motor designated by general reference 9, such that the wheel rotates in the diffuser designated by general reference 10.

According to one feature, the water wheel used for the semi-axial flow pump is a non-axisymmetrical wheel.

This has a certain number of advantages, in particular in terms of making the submersible acoustically discreet.

In fact, using a non-axisymmetrical wheel makes it possible to broaden the operating signature frequency range of the pump and reduce the amplitude of the acoustic energy radiated during the operation thereof.

One can see that by reducing this amplitude, the submersible is made more discreet and more difficult to detect.

Different wheel shapes may then be considered to meet these needs.

Likewise, the diffuser 10 has a particular shape also making it possible to improve the acoustic discretion of the engine.

In fact, and as illustrated in the various FIGS. 2 to 4, the diffuser 10 is generally in the shape of a dome for discharging the electrolyte flow at the outlet of the pump in a direction substantially parallel to the axis of that pump and the tank.

In fact, the electrolyte is pumped axially at the inlet by the pump and discharged radially at the outlet toward the diffuser, the dome shape of which makes it possible to deflect the electrolyte flow so that it is no longer oriented radially toward the wall of the tank, but axially therein toward the cell.

This then makes it possible to reduce the “acoustic bridge or column” phenomenon created between the pump and the wall of the tank of the submersible by the electrolyte flow at the outlet of the pump, and also results in reducing the noise radiated by the submersible, and therefore making the latter more discreet.

It will also be noted that at least one portion of the interface of said diffuser 10 may be provided with vanes, for example 11, with axes that are offset relative to the axis of said pump so as to initiate the rotation of the electrolyte flow at the outlet of the pump, around the axis thereof, for the same purpose as that previously mentioned, i.e., reducing the acoustic propagation of the operating noises thereof.

In the described example embodiment, the dome also makes it possible to ensure a distribution of the electrolyte discharge flow over 360° around the axis of the pump, the latter being positioned symmetrically around the axis of the pump and the tank.

This also makes it possible to improve the effectiveness of the electrolyte flow, and therefore generally the operation of the electrochemical cell.

Still other embodiments can of course also be considered.

1. A submersible, comprising an electrochemical battery activated by an electrolyte, devoted to produce the electrical power for powering said submersible, the electrochemical battery comprising:
an electrochemical cell for producing electrical power,
a tank for containing the electrolyte,
means for reducing the flow of the electrolyte between the electrochemical cell and the tank, said flow-inducing means including a semi-axial flow pump axially arranged in the tank and including a motor-driven wheel rotatably mounted in a diffuser, wherein the wheel of the pump is not axisymmetric.

2. The submersible according to claim 1, wherein the diffuser is generally in the shape of a dome for discharging the flow of electrolyte at the outlet of the pump in a direction substantially parallel to the axis of the pump and therefore of the tank.

3. The submersible according to claim 1, wherein at least part of the interface of the diffuser includes vanes with axes offset relative to the axis of the pump.

4. The submersible according to claim 2, wherein the diffuser is suitable for discharging the electrolyte at the outlet of the pump over 360° around the axis thereof.

5. The submersible according to claim 1, wherein it consists of a torpedo.

6. The submersible according to claim 2, wherein at least part of the interface of the diffuser includes vanes with axes offset relative to the axis of the pump.

7. The submersible according to claim 3, wherein the diffuser is suitable for discharging the electrolyte at the outlet of the pump over 360° around the axis thereof.

8. The submersible according to claim 2, wherein it consists of a torpedo.

9. The submersible according to claim 3, wherein it consists of a torpedo.

10. The submersible according to claim 4, wherein it consists of a torpedo.

11. The submersible according to claim 5, wherein it consists of a torpedo.

12. The submersible according to claim 6, wherein it consists of a torpedo.
